(19) United States
(12) Patent Application Publication
(10) Pub. No.: US 2003/0007672 A1
(43) Pub. Date: Jan. 9, 2003

(54) Image processing system

(75) Inventors: Philip Victor Harman, Scarborough (AU); Stephen Ronald Merralls, Wembley (AU); Patrick Joseph Heavey, Wilson (AU)

Correspondence Address: BANNER & WITCOFF, 1001 G STREET N W, SUITE 1100, WASHINGTON, DC, 20001, US

(73) Assignee: Dynamic Digital Depth Research Pty Ltd, Bentley (AU)

(21) Appl. No.: 10/024,248

(22) Filed: Dec. 21, 2001

(30) Foreign Application Priority Data
Jun. 21, 2001 (AU) PR5859

(51) Int. Cl. G06K 9/00

(52) U.S. Cl. 382/128

(57) ABSTRACT

A method of calibrating an endoscope including the steps of placing a calibration target in front of the endoscope, capturing an image frame of the calibration target by the endoscope, determining a pixel value for each pixel of the image frame, comparing each pixel value with a reference value and determining a compensation value for each pixel.

### FIELD OF INVENTION

The present invention is generally directed towards the processing of a video image from a stereoscopic endoscope. More particularly the present invention is designed to process, in real time, the video image in order to balance, or normalize, the luminance and/or chrominance levels. Additionally the invention enables the adjustment of the image position in 3D space.

### BACKGROUND

Stereoscopic endoscopes are used to view internal regions of animals or humans during minimally invasive diagnostic and surgical procedures. Such systems typically include an endoscope (which includes laparoscopes, arthroscopes, or colonoscopes), that comprises a rigid or flexible tubular optical instrument of various diameters and lengths, for insertion into an opening, natural or surgical, in the body.

A description of such systems is disclosed in a publication entitled “Three Dimensional Imaging for Minimal Access Surgery” by Mitchel et al, published October 1993, J.R. Coll. Surg. Edinb.

The stereoscopic endoscope is typically connected to a video camera. When the instrument is inserted and positioned within the patient's body, an image of the interior of the body is displayed on a stereoscopic viewing system. Such viewing systems include, although are not limited to, 3D active polarized screens, head-mounted 3D displays and LCD shutter glasses.

An alternative use of the stereoscopic endoscope is for industrial applications where 3D visualization of mechanical or structural environs is undertaken. Similar considerations are required for this field of 3D video.

A requirement of these systems is to provide real-time, high-resolution, colour, stereoscopic images. Regardless of the implementation of the endoscope, the stereoscopic video output of the camera may be in a number of formats including, although not limited to, field sequential, side-by-side, above and below, or any other stereoscopic video format.

The application of this invention covers all stereoscopic image formats.

It is known to those skilled in the art that artifacts are present in the images produced by stereoscopic endoscopes. Such artifacts are due to the constraints of producing a stereoscopic image via the small diameter optical system comprising the endoscope.

One particular artifact is the presence of an imbalance in luminance and/or chrominance levels across the video image.

Endoscopes which utilize a bundle of optical fibres, or a system of lenses, to relay an image from the objective lens at the distal end to the camera mounted at the proximal end, can be subject to various symmetric or asymmetric vignetting optical effects.

Such artifacts are addressed by Strobl et al (U.S. Pat. No. 5,751,430).

Commonly the luminance levels recovered from the periphery of the lens are lower than those near its centre. Single lens stereoscopic endoscopes, which incorporate a shutter in the form of a liquid crystal shutter or mechanical shutter, can induce luminance and/or chrominance artifacts that are manifested in the form of darkened regions on the periphery of the video image.

The prior art teaches that this is typically caused by using the left half of the lens system to form the left eye image and the right half of the lens to form the right eye image. In practice, the left and right eye images may be obtained by laterally moving the position of the CCD camera in relation to the lens. Such movement is made at video field rate. Alternatively an LCD shutter may used to obscure half of the lens for each view.

It will be appreciated that, using such techniques, different artifacts will be present in each image and therefore a global compensation cannot be applied.

In the case of field sequential 3D, these artifacts may be in the form of darkening of the sides of alternate fields. This causes stress and distraction to the user. Mechanical or optical misalignment of the shutter and the CCD element may also cause asymmetric darkened zones, exacerbating the problem.

Such artifacts are present in the single lens stereoscopic imaging system described by Greening et al (U.S. Pat. No. 6,151,164).

The prior art in this field attempts to overcome such artifacts using global adjustment where each pixel in a single frame is adjusted by the same factor. Global adjustment can be either manual using brightness, contrast, hue, saturation, and gamma controls, or automatic by the application of an automatic gain control (AGC) device.

However, as noted above, a global compensation does not alleviate the problem caused by different artifacts. There is therefore a need to provide a system which enables images of an endoscope to address the various artifacts.

Further, the apparent location in space of a stereoscopic image is dependent on the disparity between the left and right images. Altering this disparity affects the apparent position of the image in 3D space. The disparity obtained from an endoscope is usually determined by the mechanical construction of the device and is not normally adjustable.

There are occasions during a surgical procedure when it is desirable to alter the disparity in order to provide a more comfortable stereoscopic viewing experience.

### OBJECT OF THE INVENTION

It is therefore an object of this invention to describe a technique that will enable a video image to be normalized by compensating for consistent luminance and chromatic artifacts.

It is another object of this invention to provide a luminance and chrominance compensation circuit that uses a minimal amount of compensation data.

It is another object of this invention to apply compensation to the image in real time.

It is a further object of this invention to provide a method of adjusting the disparity between left and right images.

### SUMMARY OF THE INVENTION

With the above objects in mind, the present invention provides in one aspect a method of calibrating an endoscope including the steps of:

placing a calibration target in front of said endoscope;

capturing an image frame of said calibration target by said endoscope;

determining a pixel value for each pixel of said image frame;

comparing each said pixel value with a reference value; and

determining a compensation value for each pixel.

In some embodiments the calibration target may be illuminated by an external illumination source, or alternatively by said endoscope.

Ideally, the illumination of the calibration target is adjusted to avoid pixel saturation. The system may measure the luminance and chrominance of each pixel by determining the RGB components for each pixel. Further, the reference value for each pixel may be a predetermined value, or alternatively may be a pixel selected from the image frame. Preferably, if the reference value is selected from the image frame, the reference pixel will be located towards the centre of said image frame.

The compensation values may be stored for later use by the endoscope.

In a further aspect the present invention provides a method of operating a endoscope including the steps of:

capturing an image frame,

determining a value for each pixel,

applying a compensation value determined from a calibration process to each pixel, and

viewing the resultant image.

In yet a further aspect, the present invention provides a method of adjusting the disparity of an endoscope by laterally shifting left and right images in opposing directions.

### IN THE DRAWINGS

FIG. 1 shows a diagram of the use of the preferred embodiment of the invention operating in real time.

FIG. 2 show a diagram of the embodiment of the invention operating off line.

FIG. 3 shows a flow chart of the calibration process of the preferred embodiment of the present invention.

FIG. 4 shows a flow chart of the compensation process of the preferred embodiment of the present invention.

### DETAILED DESCRIPTION OF THE INVENTION

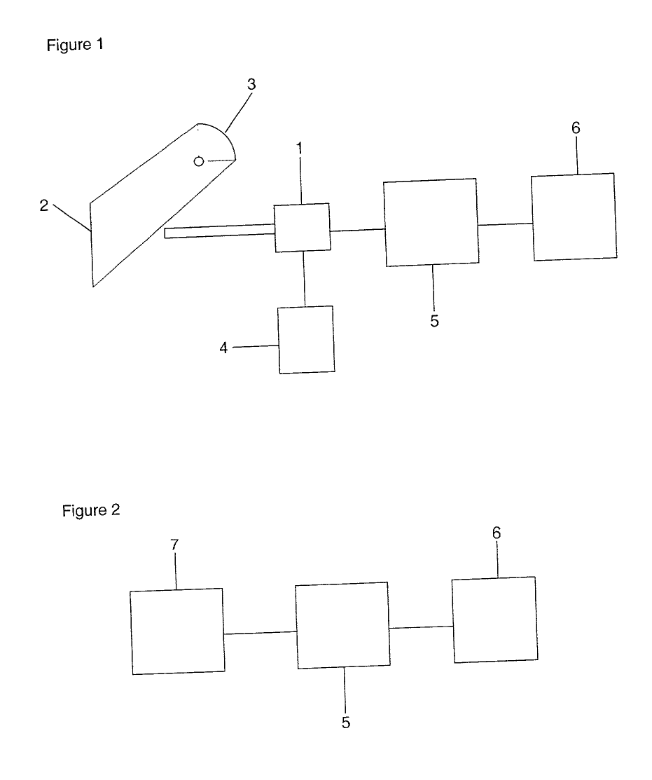

The present invention is intended to be utilised with a stereoscopic endoscope. When used in real time the system, as illustrated in FIG. 1, includes an endoscope 1, a calibration target or targets 2, an optional illumination source 3, the endoscopes integral illumination source 4, the method of the present invention 5 and a stereoscopic display system 6.

When used off line the system, as illustrated in FIG. 2, includes a video playback device 7, the method of the present invention 5 and a stereoscopic display system 6.

In the preferred embodiment, a calibration target 2 is placed in front of the lens of the endoscope. For purposes of explanation only, the target may consist of a uniformly illuminated white card placed within the field of view of the endoscope.

The level of target illumination is adjusted such that no pixel within the camera CCD array is saturated. Alternatively, a fixed illumination source may be used and the shutter period of the CCD camera adjusted to ensure non-saturation of any pixel.

Assuming a uniformly illuminated white target is used, the video image from the endoscope should be a uniformly white video image. If artifacts are present then these can be determined by measuring the luminance and chrominance values of each pixel and comparing each with those of a pure white image.

The luminance and chrominance value of each pixel can be determined by measuring its Red, Green and Blue (RGB) components. Other measurement techniques will be known to those skilled in the art and include, although are not limited to, YUV and HSV measurements.

For illustrative purposes only, consider a perfect stereoscopic endoscope imaging a uniformly illuminated white target and operating at the point of saturation. Assuming the video output from the endoscope is in NTSC format (i.e. 720 by 486 pixels) and assuming the image is digitised in 8 bit RGB mode then, the pixels in a frame of video will have the following RGB values

| Pixel (Xₘ, Yₙ) | R | G | B |
|---|---|---|---|
| 1, 1 | 255 | 255 | 255 |
| 1, 2 | 255 | 255 | 255 |
| 1, 3 | 255 | 255 | 255 |
| . . . | | | |
| 720, 486 | 255 | 255 | 255 |

For illustrative purposes only, consider a stereoscopic endoscope as above that has artifacts that cause the edges of the image to be darker than the center. The RGB values for such an endoscope may be as follows.

| Pixel (Xₘ, Yₙ) | R | G | B |
|---|---|---|---|
| 1, 1 | 200 | 200 | 200 |
| 1, 2 | 210 | 210 | 210 |
| 1, 3 | 220 | 220 | 220 |
| . . . | | | |
| 720, 486 | 200 | 200 | 200 |

Since, from the calibration card, the invention knows that each pixel should be white, a compensation value R′, G′, B′ can be calculated such that R′(xₘ,yₙ), G′(xₘ,yₙ), B′(xₘ,yₙ)=(255/R(xₘ,yₙ)), (255/G(xₘ,yₙ)), (255/B(xₘ,yₙ))

Thus for the example above the compensation values would be

| Pixel (Xₘ, Yₙ) | R′ | G′ | B′ |
|---|---|---|---|
| 1, 1 | 1.275 | 1.275 | 1.275 |
| 1, 2 | 1.214 | 1.214 | 1.214 |
| 1, 3 | 1.159 | 1.159 | 1.159 |
| . . . | | | |
| 720, 486 | 1.275 | 1.275 | 1.275 |

It will be appreciated by those skilled in the art that the compensation may take the form of an offset and/or a gain constant. Hence the general form of the compensation will be

P′(iₙ)=[(R(iₙ)+R′(iₙ)). X_{R}(iₙ)],[(G(iₙ)+G′(iₙ)).X_{G}(iₙ)],[(B(iₙ)+B′(iₙ)).X_{B}(iₙ)]

Where iₙ=(xₘ,yₙ), P′(iₙ) is a compensated pixel, X_{R}, X_{G} and X_{B} are gain constants and R′,G′ and B′ are offsets.

In a practical implementation the level of peak white may not necessarily be 255, 255, 255 due to video AGC actions etc, in which case the brightest pixel, or group of pixels, within the central zone of the captured image may be used as a reference level.

It will be appreciated by those skilled in the art that the compensation values for each pixel may be stored in a table in non-volatile memory and applied to each pixel as it is received from the camera and prior to display. Suitable non-volatile memory includes, although is not limited to ROM, EPROM, EEPROM, Flash memory, battery backed up RAM, floppy disk and hard drives.

It will also be appreciated that the compensation process can be implemented in hardware and that such hardware may also form part of the camera control system.

The compensation process may alternatively be implemented in software in either a specific computer or a general purpose computer such as a PC.

In the preferred embodiment, measurements of the non-uniformities of the luma and/or chroma distribution realized from the calibration target data are processed into a set of compensation data that can be used in real time to provide the luminance and/or chrominance correction.

The compensation may require to be altered should the artifacts present in the endoscope alter as its lens is zoomed. Different compensation coefficients may therefore be necessary at differing zoom settings.

If the endoscopic system has a feedback from the zoom setting, then this data can be used to alter an additional coefficient within the compensation algorithm.

The general from of the compensation algorithm then becomes

P40 (iₙ)=[(R(iₙ)+R′(iₙ)). X_{R}(iₙ)],[(G(iₙ)+G′(iₙ)).X_{G}(iₙ)],[(B(iₙ)+B′(iₙ)).X_{B}(iₙ)]

where iₙ=(xₘ,yₙ,zₒ) and zₒ is a coefficient dependant upon zoom setting.

Interpolation of intermediate zoom settings may also be applied. For example purposes only, this may comprise a linear average e.g.

Zₒ=(Zₙ+Zₙ₊₁)/2

It will be appreciated by those skilled in the art that other interpolation or modeling techniques may by used including, although are not restricted to, exponential, root-mean-square, 1/distance.

If the endoscopic zoom system does not provide feedback then the zoom setting (for example 0 to n) can be manually entered each time the setting is altered.

It will be appreciated that the coefficients of the algorithm are determined by calibrating the system, as described above, at each individual zoom setting.

Due to the nature of the artifacts to be corrected, it is expected that a significant percentage of adjacent pixels will require the same compensation coefficients. It is also expected that a group, or line of pixels, will require the same coefficients.

Those skilled in the art will be aware that these coefficients may be compressed using standard compression algorithms which include, although are not limited to, run length encoding, Lemple Ziv, Huffman and Shannon-Fano.

The compensation data may also be reduced when the coefficients are known to approximately model a specific function. This enables a sequence of compensation coefficients to be determined purely as a function of the x,y location of each pixel. Such expressions include, although not limited to, exponential, 1/distance, radius/angle, normal distributions.

A further aspect of the invention enables the position in space of the image to be altered when viewed on a 3D display system.

The stereoscopic image from the endoscope has a disparity predetermined by its optical design and is normally fixed. However, since the disparity determines the location of the image in 3D space it is desirable to be adjustable in order to optimize viewer comfort.

The disparity may be altered by laterally shifting the left and right images in opposing directions. That is, the images are either shifted towards or away from each other.

For example purposes only, consider the first line of the stereoscopic view sequence

Left(x,y)=Left[(1,1), (2,1), (3,1), (4,1) . . . (n,1)]

Right(x,y)=Right[(1,1), (2,1), (3,1), (4,1) . . . (n,1)]

where Left(x,y) and Right(x,y) are pixels in the left and right images respectively.

If the disparity between the two images is symmetrically increased, for example by four pixels, the sequence becomes

Left(x,y)=Left[(3,1), (4,1) . . . (n,1)(n+1,1), (n+2,1)]

Right(x,y)=Right[(0,0), (0,0)(1,1), (2,1) . . . (n-2,1)]

where (0,0), (n+1) and (n+2) are null pixels which typically will be black.

In the preferred embodiment, the disparity can be altered using the same hardware as is used for the luminance and chrominance compensation and at the same time that the luminance and chrominance compensation is applied. The disparity may be altered upon a manual command or automatically in sympathy with an external event e.g. altering the zoom setting.

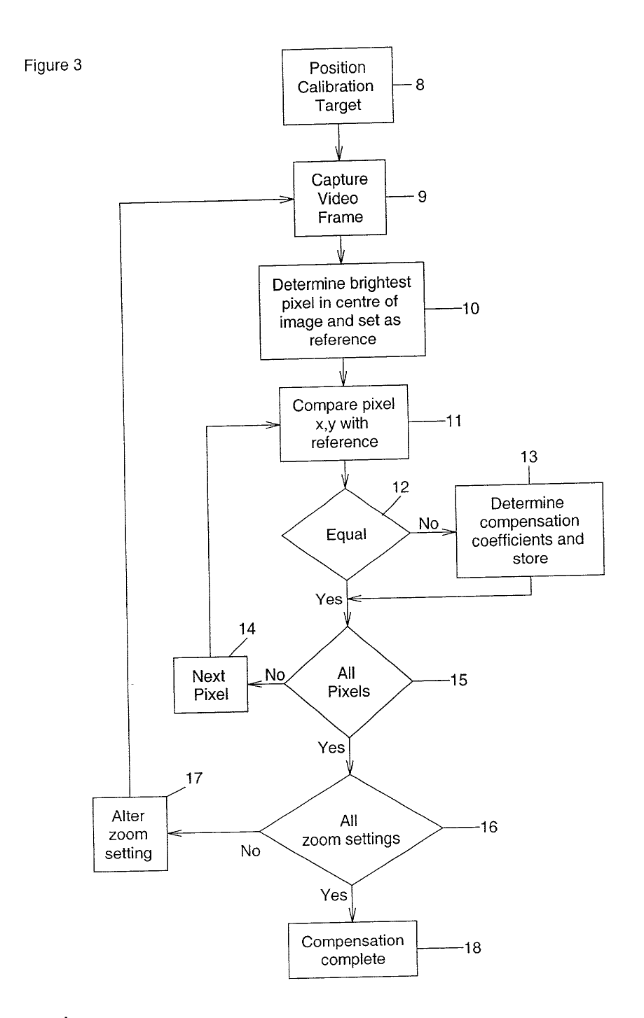

A flow chart describing the calibration process is shown in FIG. 3. Firstly, the calibration target, which has known properties is positioned 8 in front of the lens of the endoscope. The endoscope is then operated so as to capture the video frame 9. The captured video frame is then analysed to determine the brightest pixel 10. Generally, the system will look for this pixel towards the centre of the image. The brightest pixel located, is then set as a reference pixel. The system will then compare each pixel of the video frame with this reference pixel 11. If the pixel being compared is equal 12 to the reference pixel, then the next pixel 14 is compared.

Should the reference pixel not be equal to the current pixel being compared, then compensation coefficients for that pixel are determined 13. The compensation coefficient is determined by calculating what offset or proportion is required to return the compared pixel to a value equal to that of the reference pixel.

Once all pixels 15 have been compared, the system may then consider other zoom settings 17 for the endoscope. Ideally the above process will be repeated for each zoom setting 16. Alternatively, a plurality of zoom settings may be considered and compensation coefficients estimated for those zoom settings not analysed. Once this process has been completed, the calibration is complete 18 and may be utilised during normal operation of the endoscope. As previously noted, the compensation coefficients may be stored, either compressed or uncompressed, for retrieval during operation of the endoscope.

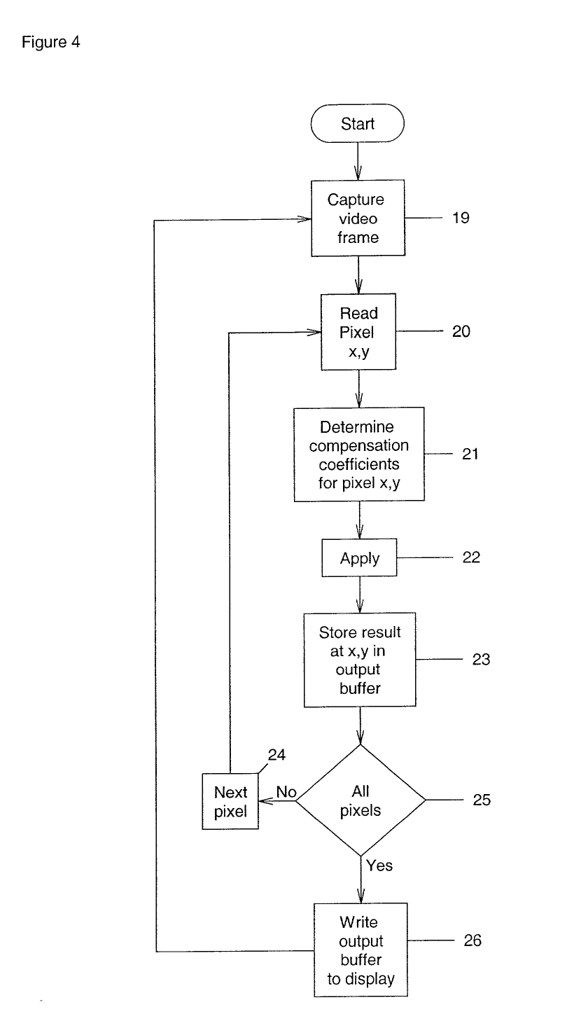

A flow chart describing the compensation process is shown in FIG. 4. During operation, the endoscope essentially captures a series of video frames which make up the images protected. Through either hardware and/or software the endoscope may use the compensation coefficients determined during the calibration process. To do so, the system captures each video frame 12 in turn. The video frame captured is then analysed to determine each pixel value 13. The system then recalls or retrieves the compensation coefficients 14 for each respective pixel. These compensation coefficients are then applied 15 to each pixel. The resultant compensated pixels are then stored in an output buffer 16 whilst the next pixel 17 is processed. Once all pixels 18 have been compensated, the output buffer is transferred to the display means 19.

In some embodiments, it may be elected to only store the compensation coefficients for pixels requiring compensation. Accordingly, the system is then not required to calculate a compensated pixel for each pixel of the frame, but rather only those pixels requiring compensation. In another alternative arrangement, the system may firstly capture those pixels requiring compensation and whilst those pixels are having the compensation applied, the remaining pixels may be captured.

In summary, accurate artifact compensation requires a local process in which each pixel within an image frame is adjusted by a different factor, as opposed to a global compensation method.

The present invention enables consistent artifacts, in the form of luminance and chrominance errors, from a stereoscopic endoscope to be compensated for. The compensation can be applied in real time or applied to video images that have been previously recorded.

In operation, a known calibration target is placed in front of the lens of the endoscope. The invention is then informed that the target is in place and automatically compensates, on a pixel by pixel bases, the luminance and chrominance value of each pixel in comparison to the value that should be obtained from the known calibration target. These compensation values can be recorded for both left and right images.

### ALTERNATIVE EMBODIMENTS

Whilst the embodiment described specifically relates to stereoscopic endoscopes it will be appreciated that the invention many be applied to other situations where artifacts require to be compensated. For example the technique may also be applied to 2D endoscopes.

In describing the invention, through the examples give, it is not intended to limit the scope of application of the invention.

It will be appreciated by those skilled in the art that the invention disclosed may be implemented in a number of alternative configurations. It is not intended to limit the scope of the invention by restricting the implementation to the embodiment described.

The claims defining the invention are as follows

1. a method of calibrating an endoscope including the steps of:
placing a calibration target in front of said endoscope;
capturing an image frame of said calibration target by said endoscope;
determining a pixel value for each pixel of said image frame;
comparing each said pixel value with a reference value; and
determining a compensation value for each pixel.

2. A method as claimed in claim 1, wherein said calibration target is a uniform white card.

3. A method as claimed in claim 1, wherein said calibration target is illuminated by an external source.

4. A method as claimed in claim 1, wherein said calibration target is illuminated by said endoscope.

5. A method as claimed in claim 3, wherein said illumination is adjusted to avoid pixel saturation.

6. A method as claimed in claim 4, wherein said illumination is adjusted to avoid pixel saturation.

7. A method as claimed in claim 3, wherein pixel saturation is avoided by adjusting the shutter period of a camera of said endoscope.

8. A method as claimed in claim 4, wherein pixel saturation is avoided by adjusting the shutter period of a camera of said endoscope.

9. A method as claimed in claim 1, wherein at least one of the luminance or chrominance values are measured to determine said pixel value for each said pixel.

10. A method as claimed in claim 1, wherein said pixel value for each said pixel is measured by determining RGB components for each said pixel.

11. A method as claimed in claim 1, wherein said reference value is a predetermined value.

12. A method as claimed in claim 1, wherein said reference value is the value of a pixel from said image frame.

13. A method as claimed in claim 1, wherein said reference value is the value of the brightest pixel from said image frame.

14. A method as claimed in claim 1, wherein said reference value is the value of a pixel located about the center of said image frame.

15. A method as claimed in claim 1, further including the step of storing said compensation values for later use.

16. A method as claimed in claim 1, wherein said compensation value for each pixel is determined by:
compensation value=reference value/actual value

17. A method as claimed in claim 1, wherein said compensation value will be:
P′(iₙ)=[(R(iₙ)+R′(iₙ)).X_{R}(iₙ) ],[(G(iₙ)+G′(iₙ)).X_{G}(iₙ)],[(B(iₙ) +B′(iₙ)).X_{B}(iₙ)]
Where iₙ=(xₘ,yₙ), P′(iₙ) is a compensated pixel, X_{R}, X_{G} and X_{B} are gain constants and R′,G′ and B′ are offsets.

18. A method as claimed in claim 17, wherein iₙ=(xₘ,yₙ,Zₒ) and Zₒ is a coefficient dependent on the zoom setting of said endoscope.

19. A method as claimed in claim 1, wherein said calibration process is calculated for each zoom setting of said endoscope.

20. A method as claimed is claim 1, wherein zoom settings are interpolated from said method.

21. A method as claimed in claim 1, wherein said compensation value are compressed.

22. A method of operating an endoscope including the steps of:
capturing an image frame,
determining a value for each pixel,
applying a compensation value determined from a calibration process to each pixel, and
viewing the resultant image.

23. A method of adjusting the disparity of an endoscope by laterally shifting left and right images in opposing directions.
